(19) United States
(12) Patent Application Publication
(10) Pub. No.: US 2026/0214045 A1
(43) Pub. Date: Jul. 23, 2026

(54) APPRATUS AND METHOD FOR ACCURATE AND RESOURCE-EFFICIENT MULTIPHTH ROUTING FOR DATA CENTER SOFTWARE SWITCHES

(71) Applicant: KOREA UNIVERSITY RESEARCH AND BUSINESS FOUNDATION, Seoul (KR)

(72) Inventors: Hyuck YOO, Seoul (KR); Yeonho YOO, Suwon-si (KR); Gyeongsik YANG, Seoul (KR); Chang-yong SHIN, Seoul (KR); Hwiju CHO, Seoul (KR)

(21) Appl. No.: 19/453,310

(22) Filed: Jan. 20, 2026

(30) Foreign Application Priority Data
Jan. 20, 2025 (KR) 10-2025-0008013

(51) Int. Cl. H04L 45/24; H04L 45/7453

(52) U.S. Cl. CPC H04L 45/24; H04L 45/7453

(57) ABSTRACT

An apparatus and a method for multi-path routing for improving accuracy and resource efficiency of a software switch in a data center are disclosed. According to an embodiment, a path selection method for multi-path routing is performed by a computing device in which a software switch is implemented, the method comprising: receiving a path weight for each path; obtaining a network connection ID (CID) of the received packet; calculating a score for each path; and selecting a path having a highest score as a path for routing.

### CROSS-REFERENCE TO RELATED APPLICATION(S)

This application claims the benefit under 35 USC § 119(a) of Korean Patent Application No. 10-2025-0008013 filed on Jan. 20, 2025, in the Korean Intellectual Property Office, the entire disclosure of which is incorporated herein by reference for all purposes.

### TECHNICAL FIELD

The present invention relates to a technique for accurately and resource-efficiently distributing network traffic of a software switch among a plurality of paths based on mathematical modeling in a data center environment. More particularly, the present invention relates to an apparatus and method for accurately and resource-efficiently distributing, by a software switch, network traffic in units of network connections (flows) in proportion to weights assigned to each path.

### BACKGROUND OF THE INVENTION

### Software Switch

A software switch is a network switch implemented in software rather than being based on conventional hardware. Compared to hardware switches, software switches have advantages in that they are flexible in configuration and management and can be easily deployed and scaled to fit a virtualization environment. It is easy to adjust network performance and size according to server resources, and various settings such as network monitoring, traffic control, and Quality of Service (QoS) are possible. Software switches are used to configure virtual networks in data centers and cloud infrastructures, or to optimize and control networks at the center of a Software-Defined Network (SDN). A representative example of a software switch is the Linux-based Open vSwitch (OVS).

### Multi-Path Routing

Multi-path routing is one of the essential network tasks of a software switch. In the case of a data center, a plurality of network paths are provided when connecting hosts, Virtual Machines (VMs), or containers. Thanks to these plurality of paths, the data center can achieve effective congestion control, thereby ensuring high throughput, low latency, and high reliability. VMs or containers have a significant number of network connections. Accordingly, the paths process various ranges of network traffic depending on the number of connections. Therefore, it is necessary to efficiently and accurately distribute network connections across a plurality of paths. Multi-path routing is a technique for distributing network connections according to weights of each path in such a situation. The weight of each path is determined according to the network conditions of each path. For example, weights are adjusted according to the degree of congestion or the size of bandwidth per path. At this time, the load of traffic distributed to each path can be effectively managed only when the weight of each path and the ratio of network connections per path become equal.

### Multi-Path Routing Operation Process in Software Switch

In a software switch, multi-path routing is performed through a packet classification process and a path selection process. For packet classification, the switch uses 5-tuple values (source IP, destination IP, source port, destination port, and transmission protocol) as input values for a hashing algorithm to obtain a network Connection ID (CID). This CID is a unique value associated with each network connection.

Thereafter, in the path selection step, the software switch determines a path through which the packet is to be transmitted based on the CID. As path selection methods, random, WRR, WCMP, and scoring techniques are used.

1) The random technique selects a path at random. Since all packets of the same network connection are transmitted through the path selected by the random technique, a problem of packet reordering does not occur. While the random technique is simple and takes relatively less time compared to other techniques, it has a disadvantage in that it cannot reflect path weights due to its randomness.

2) The WRR (Weighted Round-Robin) technique is a representative technique for reflecting path weights, and sequentially allocates paths based on the CID of a packet. The WRR first checks whether the CID has been previously processed, and if it is a network connection that has already been processed, it finds a past record and transmits the packet to the path used in the past. In the case of a CID that has not been previously processed, the WRR determines a path by referring to a weighted multi-path table. The number of entries for each path in the multi-path table is proportional to the weight of the path. The WRR must manage a cache for storing CID processing results, a weighted multi-path table, and a position pointer indicating the next path to be used; when the number of table entries is n, it shows a time increase proportional to the number of entries.

3) WCMP (Weighted Cost Multipath Routing) is a technique for reducing high memory usage occurring in WRR. In WRR, memory consumption increases because multiple entries corresponding to the weights of each path must be created in the weighted multi-path table. WCMP sets a maximum number of table entries (T) and reduces the total number of table entries by modifying given path weights to be less than or equal to T. In this process, although path weights are maintained as integer values, the ratio of weights may be distorted, which may affect accuracy.

4) The scoring technique uses an additional hash function to reduce the complexity of reflecting weights during path selection. This is a method in which weights are reflected in a rendezvous hashing technique. A hash value using the CID and a path ID as inputs is generated, and this hash value is multiplied by the path weight to calculate a final score. At this time, the path having the highest score is selected. Since the scoring technique determines a path using only a hash algorithm and multiplication, the execution time is always maintained constant. For this reason, scoring techniques are widely used in software switches such as Open vSwitch (OVS).

### DISCLOSURE

### Technical Problem

A technical problem to be solved by the present invention is to provide an apparatus and method for multi-path routing to improve accuracy and resource efficiency of a software switch in a data center.

### Technical Solution

According to an embodiment of the present invention, a path selection method for multi-path routing is performed by a computing device in which a software switch is implemented, the method comprising receiving a path weight for each path, obtaining a network Connection ID (CID) of a received packet, calculating a score for each path, and selecting a path having a highest score as a path for routing.

### Advantages Effects

According to the apparatus and method for multi-path routing according to an embodiment of the present invention, there is an effect of improving accuracy of multi-path routing and efficiency of resources used for the operation.

### BRIEF DESCRIPTION OF DRAWINGS

In order to more fully understand the drawings cited in the detailed description of the present invention, a detailed description of each drawing is provided.

FIG. 1 is a graph showing an error rate regarding a ratio of actually distributed traffic relative to a given weight.

FIG. 2 is a graph showing CPU consumption (cycles) consumed for multi-path routing.

FIG. 3 shows an example of a score graph when the total number of paths is three.

FIG. 4 shows an example of a score graph when the total number of paths is two.

FIG. 5 illustrates a conventional scoring technique.

FIG. 6 is a view for explaining an operation method and a role of the present invention in comparison with a conventional scoring technique.

FIG. 7 shows an example of volume calculation when the total number of paths is two.

FIG. 8 shows an example of volume calculation when the total number of paths is three.

FIG. 9 is a graph showing error rates sorted in ascending order when executed 200 times while randomly changing weights.

FIG. 10 is a graph showing an increasing trend in the total number of network connections.

FIG. 11 is a graph showing an increasing trend in the total number of paths.

FIG. 12 is a graph showing CPU consumption according to an increase in the number of network connections.

FIG. 13 is a graph showing CPU consumption according to an increase in the total number of paths.

FIG. 14 is a graph comparing latency required for multi-path routing per packet according to an increase in the number of network connections.

FIG. 15 is a graph comparing latency required for multi-path routing per packet according to an increase in the total number of paths.

FIG. 16 shows a comparison result of memory usage according to an increase in the number of network connections.

FIG. 17 shows a comparison result of memory usage according to an increase in the total number of paths.

FIG. 18 is a flowchart for explaining a path selection method for multi-path routing according to an embodiment of the present invention.

### DETAILED DESCRIPTION OF THE INVENTION

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Hereinafter, example embodiments will be described with reference to the accompanying drawings. However, the scope of the patent application is not limited to or restricted by such example embodiments. Like reference numerals used herein refer to like elements throughout.

First, definitions of terms used in the present specification are as follows.

Data center: A data center is a facility where hundreds or thousands of servers, network equipment, and storage are gathered for large-scale data storage and processing. In a data center, various applications and services are operated simultaneously, through which enterprises can effectively provide data management and business applications. A data center is equipped with a stable power supply, a cooling system, security devices, and the like to protect important data and support high-speed data transmission and processing.

Network connection: Communication between two processes running on two servers is referred to as one network connection. Generally, this is performed using a connection-oriented Transmission Control Protocol (TCP), and data is exchanged between processes through the network connection. Unicast communication in a User Datagram Protocol (UDP) may also form one network connection because data is exchanged between two processes. In the present invention, if at least some of header information of a TCP packet, for example, 5-tuple information (source IP address, destination IP address, source port address, destination port address, and L4 protocol identifier), are the same, it is considered as one TCP network connection.

Congestion control: Congestion control refers to a mechanism for managing and mitigating a congestion state that may occur during data transmission in a network. Network congestion occurs as network traffic increases, which may lead to packet loss, delay, and overall performance degradation. Therefore, congestion control is essential to ensure stable and efficient data transmission.

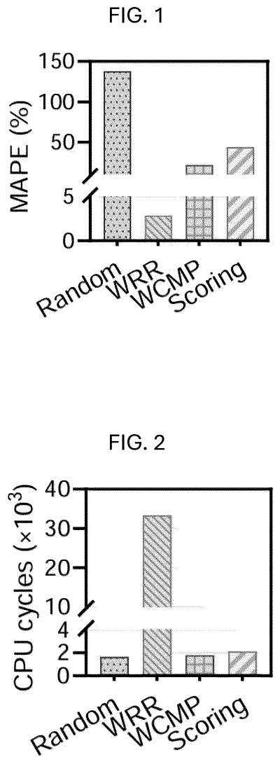

Conventional congestion control studies using weights are conducted under the assumption that a software switch will accurately distribute network connections according to weights of each path and that multi-path routing does not cause a bottleneck in the software switch. Accordingly, conventional studies focus only on determining and adjusting path weights that reflect network conditions. However, in the present invention, it has been confirmed through experiments that conventional software switches fail to accurately distribute network connections according to given weights or that there is a significant overhead in multi-path routing. This can be confirmed through FIG. 1, which illustrates accuracy of path selection methods according to given weights, and FIG. 2, which illustrates CPU utilization of each path selection method. Accordingly, the present invention intends to provide a new path selection method for achieving high accuracy and resource-efficient multi-path routing.

Hereinafter, limitations and implications of a scoring technique will be described.

Inaccuracy of the scoring technique will be explained through a score graph. The score graph proposed in the present invention is a multi-dimensional model representing how network connections are distributed across multiple paths.

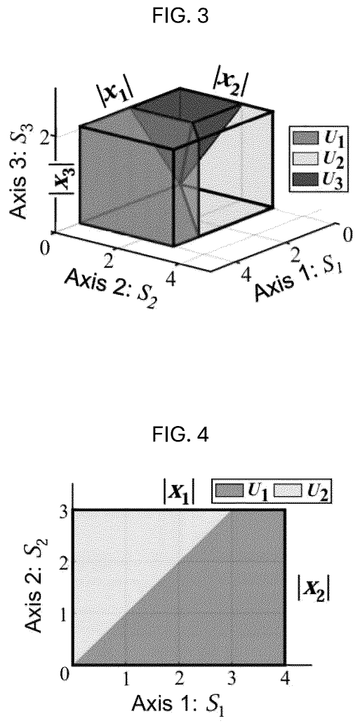

When multi-path routing is performed in n (n is a natural number) paths, a score graph (In) models and estimates unprocessed network connections as a set of points. For each path i (1≤i≤n), a variable representing a path weight is denoted as xᵢ. For a j-th unprocessed network connection, a score value of path i is denoted as sᵢⱼ. Each axis i (e.g., Axis 1, Axis 2, and Axis 3 in FIG. 3) represents a value of Sᵢ(=∪ⱼsᵢⱼ), and points representing the j-th network connection are denoted as (s₁ⱼ, s₂ⱼ, . . . , sₙⱼ).

For example, a score graph for a j-th network connection for three paths I₃ consists of points indicated as (sᵢⱼ, S₂ⱼ, S₃ⱼ) on Axis 1, Axis 2, and Axis 3 in *FIG. 3. Each axis represents values of S₁, S₂, and S₃. For instance, assume that a k-th network connection exists and its HP values (which may mean a result value of a hash function taking a CID and a path ID as inputs) for three paths are 0.4, 0.2, and 0.3, respectively. If values of x₁, x₂, and x₃ are 4, 3, and 2, respectively, then s₁ₖ, s₂ₖ, and s₃ₖ values become 1.6, 0.6, and 0.6, respectively. Accordingly, the corresponding network connection is represented as a point (1.6, 0.6, 0.6) in I₃.

As such, Iₙ can represent scores of all unprocessed network connections. To simplify modeling, it is assumed that the range of the HP value for each axis is between 0 and 1 (this may be achieved by limiting the output of the hash function to 0~1 or normalizing the output to 0~1). If an actual HP value in the hash function exceeds 1, it is adjusted to 1 or less by scaling it down by an appropriate ratio. The score sᵢⱼ is calculated by multiplying the path weight xᵢ and the output (HP value) of the hash function. Accordingly, the range of Sᵢ is between 0 and xᵢ.

Next, for each network connection, the scoring technique selects a path having the highest sᵢⱼ value among all paths. In a graph consisting of two paths (FIG. 4), consider a point (0.8, 1.5) located within a blue region (indicated as U₂). At this point, since s₂ⱼ (1.5) is greater than sᵢⱼ (0.8), this network connection takes Path 2. Also, in a graph consisting of three paths (FIG. 3), an arbitrary point sᵢⱼ, s₂ⱼ, s₃ⱼ) may be considered. At this point, if sᵢⱼ is greater than s₂ⱼ and s₃ⱼ, this network connection takes Path 1. This point exists within a green region (U₁) of FIG. 3. Generalizing these examples, Uᵢ is defined as a set of points taking path i. The definition is as follows:

$${U}_{i} = {⋃}_{j} {s}_{ij} \leq {s}_{1 j} ⋂ {s}_{ij} \geq {s}_{2 j} ⋂ … ⋂ {s}_{ij} \geq {s}_{nj} = {⋃}_{j} {⋂}_{1 \leq n \leq n} {s}_{ij} \geq {s}_{mj}$$

A union of Uᵢ is defined as a score graph (Iₙ) for n paths. That is, Iₙ=∪_{1≤i≤n}Uᵢ.

To show the inaccuracy of the scoring technique, the number of points directed to each path was estimated based on the defined Uᵢ and Iₙ. For path i, the number of points existing in Uᵢ is counted, because points in Uᵢ will select path i. However, counting individual points is very difficult and inefficient. This is because 5-tuple values including IP addresses and port numbers can theoretically allow trillions of unique network connections. Therefore, instead of counting each point, a method of measuring a “volume” of Uᵢ was used. This volume is denoted as vol(Uᵢ). The volume represents a size of the region (Uᵢ), and according to embodiments, may mean an area.

It is assumed that values of Sᵢ are uniformly distributed along each axis. Reasons why this assumption is valid are as follows. First, conventional hash functions are designed to distribute values uniformly (HP values) to avoid duplicate values. Therefore, since Sᵢ is a product of constants (weight×HP value), it follows a uniform distribution. In addition, representative hash functions were experimented with, and a hash function most similar to a uniform distribution was selected. Also, instead of counting individual points, vol(Uᵢ) was calculated through surface integration or volume integration. It can be said that the number of network connections is proportional to vol(Uᵢ).

To verify this, the ratio of path weights and vol(Uᵢ) was compared. In the present invention, a multi-path routing experiment was conducted with 20K network connections using a CAIDA dataset. Experiments were performed for (1) a case where x₁ and x₂ values of two paths are 4 and 3, respectively (FIG. 4), and (2) a case where x₁, x₂, and x₃ values of three paths are 4, 3, and 2, respectively (FIG. 3).

In the case of the two-path experiment (1), the two paths delivered 12634 and 7466 connections, respectively. The ratio of the number of connections for each path is 5:2.97, which shows a significant difference from the assigned path weight ratio of 4:3. On the other hand, when vol(U₁) and vol(U₂) are calculated through surface integration, a ratio of 5:3 can be obtained. This ratio almost coincides with the ratio in which actual network connections are distributed. In the case of the three-path experiment (2), the experimental results show that network connections were distributed in a ratio of 5.05:2.81:1 (11400, 6342, 2258). This is significantly different from the assigned path weight ratio of 4:3:2. However, the ratio of vol(U₁), vol(U₂), and vol(U₃) is 5.13:2.88:1, which is quite similar to the distribution ratio of actual connections. The above experiments show that although the scoring technique deviates from the path weights in network connection distribution, the ratio of vol(Uᵢ) is very similar to the actual network connection distribution ratio.

Hereinafter, embodiments of the present invention will be described in detail.

The present invention provides a method for a software switch to accurately and resource-efficiently distribute network traffic in units of network connections (flows) in proportion to weights of each path based on mathematical modeling.

To improve the accuracy of the conventional scoring technique described above, a method (referred to as VALO) is proposed. The proposed technique ensures that vol(Uᵢ) matches a given path weight.

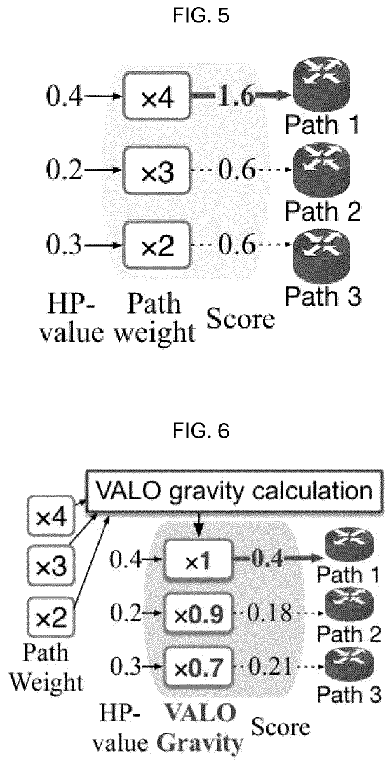

FIG. 5 illustrates a conventional scoring technique, and FIG. 6 is a view for explaining an operation method and a role of the present invention in comparison with the conventional scoring technique. When an external network controller (e.g., an SDN controller) or a data center operator inputs path weight values into a software switch, the conventional scoring technique (FIG. 5) uses them directly. In contrast, according to the present invention, after receiving the path weights, a score is calculated by computing a new parameter (referred to as VALO gravity) value (FIG. 6). Each time the path weights are updated, the proposed technique calculates a VALO gravity value for each path. The VALO gravity value is determined such that a ratio of the volume of each region in a score graph is close to a ratio of the path weights. Using the VALO gravity, the present invention calculates a score by multiplying an HP value by the VALO gravity instead of the given path weight, and then selects a path having the highest score.

The VALO gravity, which may also be referred to as an adjusted path weight, can be obtained by calculating a path weight variable xᵢ and vol(Uᵢ). While vol(Uᵢ) can be calculated using surface integration or volume integration, the computational complexity increases significantly as the number of paths increases because the axes and dimensions of the score graph increase. Therefore, instead of volume integration, an efficient method for calculating vol(Uᵢ) is proposed.

The method for calculating vol(Ui) is as follows:

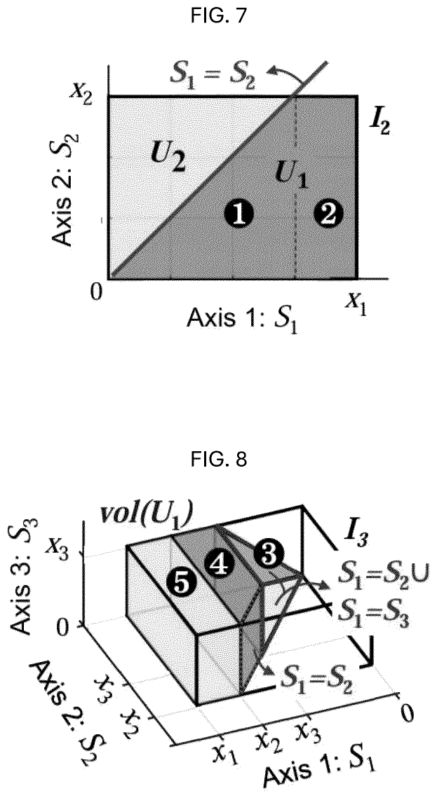

FIG. 7 shows a score graph for two paths I₂. Axis 1 and Axis 2 represent S₁ and S₂ values, respectively, where the range of Axis 1 is 0 to x₁ and the range of Axis 2 is 0 to x₂. Assuming x₁>x₂, the length of Axis 1 is longer, and the score graph consists of a union of U₁ and U₂. Specifically, U₁ represents s₁ⱼ≥S₂ⱼ, and U₂ represents sᵢⱼ≤s₂ⱼ. Thus, U₁ (green) and U₂ (blue) are divided by s₁ⱼ=s₂ⱼ (red line).

Next, vol(Uᵢ) is calculated in FIG. 7. The area of U₁ is divided into a triangle (\textcircled{1}) and a rectangle (\textcircled{2}). Thus, vol(U₁) is calculated by Equation 1a. And, vol(U₂) is calculated by Equation 1b.

$$vol ( {U}_{1} ) = \frac{1}{2} {x}_{2}^{2} + ( {x}_{1} {x}_{2} - {x}_{2}^{2} ) \qquad [ Equation 1 a ]$$

$$vol ( {U}_{2} ) = \frac{1}{2} {x}_{2}^{2} \qquad [ Equation 1 b ]$$

In FIG. 8, I₃ with x₁, x₂, x₃ is considered. I₃ is a union of U₁, U₂, U₃. Axes 1, 2, and 3 represent S₁, S₂, S₃ values, with ranges 0 to x₁, x₂, and x₃, respectively. FIG. 8 shows the vol(U₁) region subdivided into three parts (\textcircled{3}, \textcircled{4}, \textcircled{5})). The vol(U₁) region is divided by two planes: 1) s₁ⱼ=s₂ⱼ∪s₁ⱼ=s₃ⱼ (triangular plane with a solid red line) and 2) s₁ⱼ=s₂ⱼ (rectangular plane with a dotted red line). The volumes of 3, 4, and 5 are calculated similarly to the I₂ example, as shown in Equation 2a. Similarly, vol(U₂) and vol(U₃) are calculated by Equation 2b and Equation 2c, respectively.

$$vol ( {U}_{1} ) = \frac{1}{3} {x}_{3}^{3} + \frac{1}{2} ( {x}_{2}^{2} {x}_{3} - {x}_{3}^{3} ) + ( {x}_{1} {x}_{2} {x}_{3} - {x}_{2}^{2} {x}_{3} ) \qquad [ Equation 2 a ]$$

$$vol ( {U}_{2} ) = \frac{1}{3} {x}_{3}^{3} + \frac{1}{2} ( {x}_{2}^{2} {x}_{3} - {x}_{3}^{3} ) \qquad [ Equation 2 b ]$$

$$vol ( {U}_{3} ) = \frac{1}{3} {x}_{3}^{3} \qquad [ Equation 2 c ]$$

The regularity of vol(Uᵢ) can be observed through the above examples. For n paths, the first term is divided by 1/n, the second by 1/(n−1), and so on. Thus, vol(Uᵢ) can be generalized via mathematical induction as follows (Equation 3a, Equation 3b):

$${X}_{i} = \{ \begin{matrix}{x}_{i}^{j} {x}_{i + 1} … {x}_{n} & i \leq n \\ 0 & i > n\end{matrix} \qquad [ Equation 3 a ]$$

$$vol ( {U}_{i} ) = {{\sum }_{m = i}}^{n} \frac{1}{m} ( {X}_{m} - {X}_{m + 1} ) \qquad [ Equation 3 b ]$$

The method for calculating the VALO gravity is as follows:

Based on Equation 3b, a method for calculating VALO gravity is proposed. Representing Equation 3b as a matrix results in Equation 4.

$$[ \begin{matrix}vol ( {U}_{1} ) \\ vol ( {U}_{2} ) \\ vol ( {U}_{3} )\end{matrix} ] = [ \begin{matrix}1 & \frac{1}{2} & \frac{1}{3} & … & \frac{1}{n} \\ & \frac{1}{2} & \frac{1}{3} & … & \frac{1}{n} \\ & & \frac{1}{3} & … & \frac{1}{n} \\ & & & ⋱ & ⋮ \\ & & & & \frac{1}{n}\end{matrix} ] [ \begin{matrix}1 & - 1 & & & \\ & 1 & - 1 & & \\ & & & ⋱ & \\ & & & 1 & - 1 \\ & & & & 1\end{matrix} ] [ \begin{matrix}{X}_{1} \\ {X}_{2} \\ {X}_{3} \\ ⋮ \\ {X}_{n}\end{matrix} ] \qquad [ Equation 4 ]$$

Xᵢ values can be obtained by multiplying Equation 4 by an inverse matrix, resulting in Equation 5.

$$[ \begin{matrix}{X}_{1} \\ {X}_{2} \\ {X}_{3} \\ ⋮ \\ {X}_{n}\end{matrix} ] = [ \begin{matrix}1 & 1 & 1 & … & 1 \\ & 1 & 1 & … & 1 \\ & & 1 & … & 1 \\ & & & ⋱ & 1 \\ & & & & 1\end{matrix} ] [ \begin{matrix}1 & - 1 & & & \\ & 2 & - 2 & & \\ & & & ⋱ & \\ & & & n - 1 & n + 1 \\ & & & & n\end{matrix} ] [ \begin{matrix}vol ( {U}_{1} ) \\ vol ( {U}_{2} ) \\ vol ( {U}_{3} ) \\ ⋮ \\ vol ( {U}_{n} )\end{matrix} ] \qquad [ Equation 5 ]$$

Then, Xᵢ can be calculated based on Equation 5 (Equation 6a, Equation 6b).

$$[ \begin{matrix}{X}_{1} \\ {X}_{2} \\ {X}_{3} \\ ⋮ \\ {X}_{n}\end{matrix} ] = [ \begin{matrix}vol ( {U}_{1} ) + vol ( {U}_{2} ) + vol ( {U}_{3} ) + … + vol ( {U}_{n} ) \\ vol ( {U}_{2} ) + vol ( {U}_{3} ) + … + vol ( {U}_{n} ) \\ vol ( {U}_{3} ) + … + vol ( {U}_{n} ) \\ ⋮ \\ nvol ( {U}_{n} )\end{matrix} ] \qquad [ Equation 6 a ]$$

$${X}_{i} = ivol ( {U}_{i} ) + vol ( {U}_{i + 1} ) + … + vol ( {U}_{n} ) \qquad [ Equation 6 b ]$$

In Equation 6b, the goal is to find xᵢ. By dividing xᵢ by x₁, it can be simplified into a form calculable using only addition and multiplication. An example of x₂/x₁ is Equation 7. By multiplying the numerator and denominator by x₂× . . . ×xₙ, xᵢ can be replaced with xᵢ or vol(Uᵢ) using Equation 3a and Equation 6b, respectively.

$$\frac{{x}_{2}}{{x}_{1}} = \frac{{x}_{2}^{2} \times … \times {x}_{n}}{{x}_{1} \times {x}_{2} \times … \times {x}_{n}} = \frac{{X}_{2}}{{X}_{1}} \frac{2 vol ( {U}_{2} ) + … + vol ( {U}_{n} )}{vol ( {U}_{1} ) + … + vol ( {U}_{n} )} \qquad [ Equation 7 ]$$

The ratios x₃/x₁ and x₄/x₁ are obtained similarly. The result is Equation 8. The ratio xᵢ/x₁ is generalized as Equation 9 using a mathematical induction. Equation 9 is valid only for i>1. if i=1, xᵢ/x₁=1.

$$\frac{{x}_{3}}{{x}_{1}} = \frac{{X}_{2}}{{X}_{1}} \times {( \frac{{X}_{3}}{{X}_{2}} )}^{\frac{1}{2}} = \frac{{x}_{2}}{{x}_{1}} \times {( \frac{3 vol ( {U}_{3} ) + … + vol ( {U}_{n} )}{2 vol ( {U}_{2} ) + … + vol ( {U}_{n} )} )}^{\frac{1}{2}} \qquad [ Equation 8 ]$$

$$\frac{{x}_{4}}{{x}_{1}} = \frac{{X}_{2}}{{X}_{1}} \times {( \frac{{X}_{3}}{{X}_{2}} )}^{\frac{1}{2}} \times {( \frac{{X}_{4}}{{X}_{3}} )}^{\frac{1}{3}} = \frac{{x}_{3}}{{x}_{1}} \times {( \frac{4 vol ( {U}_{4} ) + … + vol ( {U}_{n} )}{3 vol ( {U}_{3} ) + … vol ( {U}_{n} )} )}^{\frac{1}{3}}$$

$$\frac{{x}_{i}}{{x}_{1}} = {{\prod }_{k = 2}}^{i} {( \frac{kvol ( {U}_{k} ) + vol ( {U}_{k + 1} ) + … + vol ( {U}_{n} )}{( k - 1 ) vol ( {U}_{k - 1} ) + vol ( {U}_{k} ) + … + vol ( {U}_{n} )} )}^{\frac{1}{k - 1}} \qquad [ Equation 9 ]$$

To ensure vol(Uᵢ) matches a given weight ratio (wᵢ), wᵢ is substituted into vol(Uᵢ). Through this substitution, xᵢ/x₁ becomes the VALO gravity value in Equation 10.

$$\frac{{x}_{i}}{{x}_{1}} = {{\prod }_{k = 2}}^{i} {( \frac{{kw}_{k} + {w}_{k + 1} + … {w}_{n}}{( k - 1 ) {w}_{k - 1} + {w}_{k} + … + {w}_{n}} )}^{\frac{1}{k - 1}} \qquad [ Equation 10 ]$$

As an example applied with the induced equation, if given path weights for three paths are 4, 3, 2, the VALO gravity values are calculated as 1, 0.889, 0.726, respectively. And then, the present invention performs multi-path routing using these values as path weights. Since VALO gravity is calculated using only Equation 10 in the present invention when wᵢ is updated, it can be obtained without significant computational overhead. VALO gravity is updated whenever weight values are altered.

Hereafter, effects obtained by embodiments of the present invention are described.

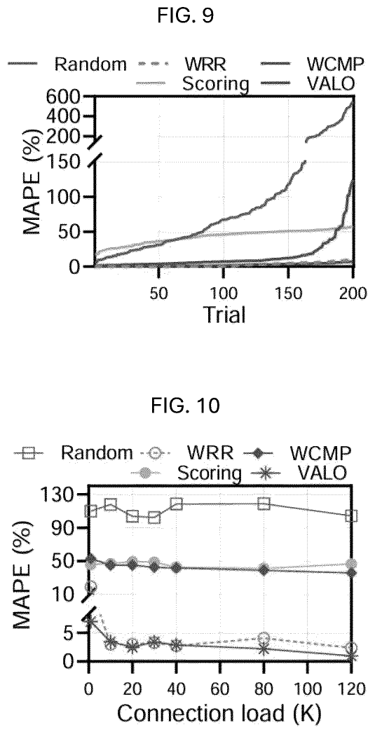

FIG. 9 shows the Mean Absolute Percentage Error (MAPE) for each multi-path routing technique for the given path weight. For results of 200 experiment, the proposed technique (VALO) recorded an average error of 2.3% and a maximum error of 7.3%, outperforming WRR (2.5%, 10.5%). In contrast, random, WCMP, and scoring showed high errors of 104.2%, 14.1%, and 43%, respectively. Proposed VALO is 46.3, 6.3, and 19.1 times more accurate than Random, WCMP, and Scoring, respectively.

FIG. 10 illustrates the Mean Absolute Percentage Error (MAPE) according to an increase in the number of network connections. The proposed technique (VALO) shows, on average, 13.1 times higher performance compared to other techniques. In particular, the random technique showed the highest average error of 110.6%, followed by the WCMP technique with 42.8% and the scoring technique with 45.5%, showing high error rates. WRR recorded a relatively low error rate of 5.3%. In contrast, the proposed technique (VALO) maintains the lowest error rate of 3.2%, demonstrating stable accuracy regardless of the number of network connections.

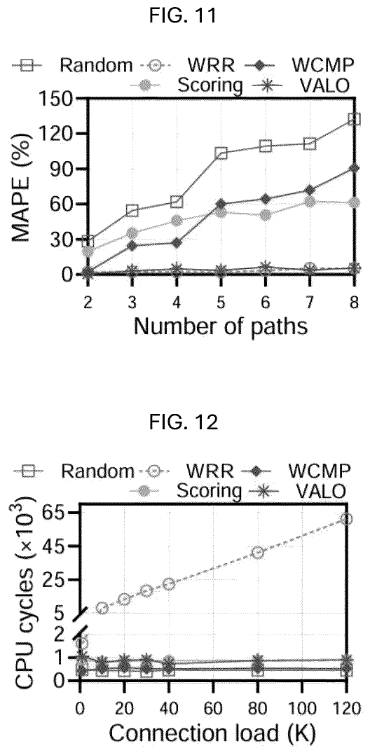

FIG. 11 illustrates the Mean Absolute Percentage Error (MAPE) for each multi-path routing technique as the number of paths increases. The average error of the proposed technique (VALO) is 9.4 times lower than that of other techniques, demonstrating superior performance. While the error rates of the random, WCMP, and scoring techniques increase significantly, the proposed technique (VALO) maintains a low error of 4% and shows no performance degradation according to the number of paths. Compared to the random, WCMP, and scoring techniques, the proposed technique (VALO) exhibits error reduction effects of 21.5 times, 11.8 times, and 11.8 times, respectively.

The proposed technique (VALO) shows outstanding performance in terms of CPU usage compared to other techniques. According to FIG. 12, the proposed technique (VALO) uses CPU cycles at a level similar to those of the random, WCMP, and scoring techniques, all of which are maintained below 1,000 CPU cycles. In contrast, WRR has significantly higher CPU usage than other techniques and consumes, on average, 26.8 times more CPU cycles than the proposed technique. Furthermore, even as the number of connections increases, the CPU usage of the random, WCMP, scoring, and VALO techniques remains stable, whereas the CPU usage of WRR increases by 38.1 times, further emphasizing the performance difference.

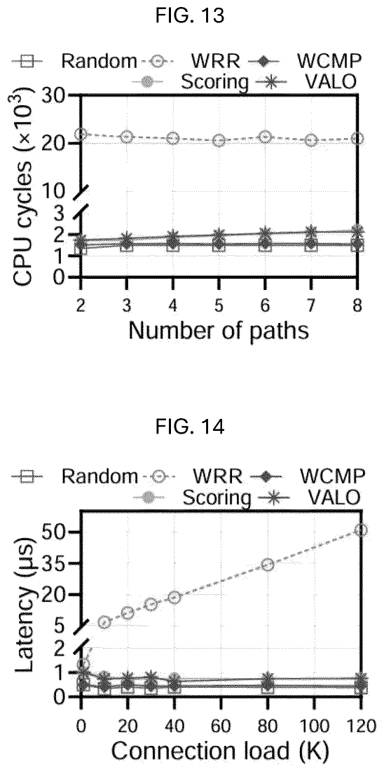

Referring to FIG. 13, even as the number of paths increases, the proposed technique (VALO) maintains a level of CPU usage similar to those of the other techniques while consuming, on average, 10.7 times fewer CPU cycles than WRR. While WRR provides high accuracy, its efficiency in terms of CPU resources is very low because it must maintain complex table lookups and structures. In contrast, the proposed technique (VALO) exhibits outstanding performance by significantly reducing CPU consumption while maintaining accuracy similar to that of WRR.

In conclusion, the proposed technique (VALO) exhibits superior performance compared to other multi-path routing techniques in terms of performance and efficiency, and provides effective multi-path routing without loss of accuracy while significantly reducing CPU resource consumption.

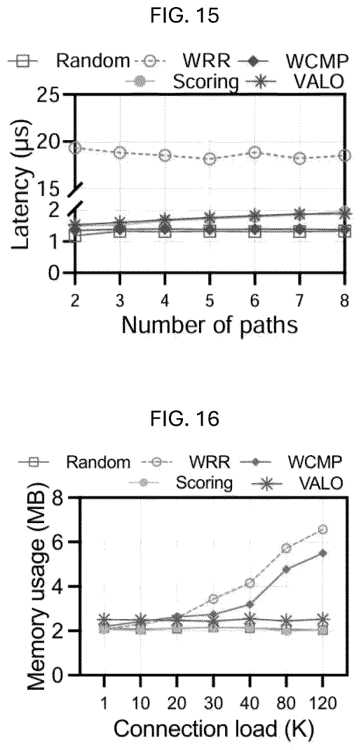

FIGS. 14 and 15 illustrate latency of multi-path routing as connection load and the number of paths increase. A result similar to the trend shown in the CPU usage result (FIG. 12) can be observed. When the connection load increases (FIG. 14), the proposed technique maintains a latency similar to those of the random, WCMP, and scoring techniques, all of which recorded a latency of 1 μs or less. In contrast, WRR shows the highest latency, recording a latency of approximately 50.9 μs at 120K connections. The average latency of the proposed technique is 25.4 times better than that of WRR, and 67.7 times better at the maximum of 120K connections.

In addition, when the number of paths increases from 2 to 8 (FIG. 15), WRR records the highest latency with an average of 18.6 μs. Conversely, the random, WCMP, scoring, and proposed techniques show relatively similar latency levels (average 1.5 μs), demonstrating performance improved by 12.1 times compared to WRR. Similar to the CPU usage results, the proposed technique significantly improves latency, proving its superiority in accuracy and resource efficiency.

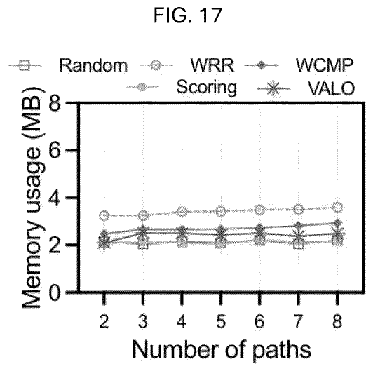

FIGS. 16 and 17 illustrate memory usage of multi-path routing techniques as connection load and the number of paths increase. When the connection load increases (FIG. 16), the random, WRR, scoring, and proposed techniques show consistent memory usage across all connection loads, being maintained at an average of 2.2 MB. In contrast, WRR and WCMP significantly increase in memory consumption as the connection load increases (increasing by 3.2 times and 2.5 times, respectively, as the load increases from 1K to 120K connections). Compared to the proposed technique, the average memory consumption of WRR and WCMP is 1.5 times and 1.3 times higher, respectively, and shows values 2.6 times and 2.2 times higher at the peak.

Next, when the number of paths increases (FIG. 17), all techniques show stable memory usage. WRR records the highest memory consumption with an average of 3.4 MB, followed by WCMP with an average of 2.7 MB. Compared to the proposed technique, the memory consumption of WRR and WCMP is 41.4% and 12% higher, respectively.

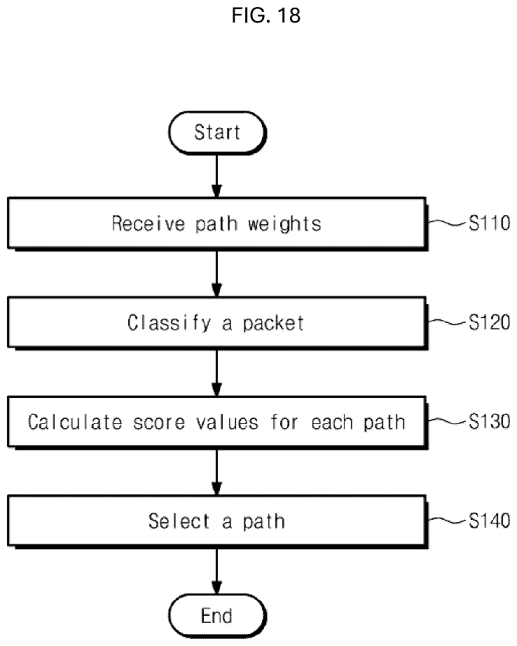

FIG. 18 is a flowchart for explaining a path selection method for multi-path routing according to an embodiment of the present invention.

The path selection method may be performed by a computing device in which a software switch is implemented. Accordingly, at least some of the steps constituting the path selection method may be understood as operations of a processor included in the computing device, and the computing device may be referred to as a path selection apparatus or a software switch apparatus. In addition, the software switch may be understood as, for example, a part of a configuration of a Software-Defined Network (SDN). The computing device includes a personal computer (PC), a server, and the like. Hereinafter, in describing the path selection method, detailed descriptions of contents overlapping with the previous descriptions will be omitted.

A path weight for each of a plurality of paths is received (S110). The path weights may be received from an external controller (e.g., an SDN controller) or may be input by an administrator. According to an embodiment, the path weights may be received and stored in advance.

A packet classification operation is performed (S120). More specifically, a network connection ID (CID) of a packet may be obtained by using information (e.g., 5-tuple information) of a received packet as an input value of a hashing algorithm. At this time, if a path for the corresponding CID has already been determined, the corresponding packet may be routed to the determined path. That is, for a packet having a previous processing history, it may be routed to a previously used path.

If the path for the obtained CID has not been determined, a score value for each path is calculated to select a path (S130). The score value for each path is a result of multiplying an HP value by a parameter value corresponding to the path weight. At this time, the parameter value corresponding to the path weight may be calculated through Equation 10, and the HP value refers to an output of a hash function taking the CID and a path ID as inputs.

A path for routing the packet is selected (S140). Specifically, a path representing the highest score value may be selected. Accordingly, the received packet is transmitted to the selected (or determined) path.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

Although the present invention is described with reference to the example embodiments illustrated in the drawings, it is provided as an example only and it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A path selection method for multi-path routing, performed by a computing device in which a software switch is implemented, the method comprising:
receiving a path weight for each path;
obtaining a network connection ID (CID) of the received packet;
calculating a score for each path; and
selecting a path having a highest score as a path for routing.

2. The method of claim 1,
wherein the CID is a result value of a hash function taking as inputs a source IP address, a destination IP address, a source port address, a destination port address, and an L4 protocol identifier of the packet.

3. The method of claim 2,
wherein the calculating of the score comprises:
calculating a hashing value of the CID and a path ID; and
multiplying the hashing value by an adjusted path weight calculated based on the path weight.

4. The method of claim 3,
wherein an adjusted path weight (xᵢ/x₁) for an i-th path (i is a natural number between 1 and n, where n is an arbitrary natural number) among the adjusted path weights is calculated by an equation,
wherein the equation is:
$$\frac{{x}_{i}}{{x}_{1}} = {{\prod }_{k = 2}}^{i} {( \frac{{kw}_{k} + {w}_{k + 1} + … {w}_{n}}{( k - 1 ) {w}_{k - 1} + {w}_{k} + … + {w}_{n}} )}^{\frac{1}{k - 1}}$$
and wherein wᵢ is a path weight of the i-th path.

5. The method of claim 4,
wherein the receiving of the path weight for each path comprises receiving the path weight for each path from a Software-Defined Network (SDN) controller.

6. The method of claim 5,
further comprising routing the packet to the selected path.
